(19) United States
(12) Patent Application Publication
(10) Pub. No.: US 2007/0017524 A1
(43) Pub. Date: Jan. 25, 2007

(54) TWO-STAGE GAS REGULATING ASSEMBLY

(76) Inventors: Henry Martin Wilson JR., Buford, GA (US); David Gerson, Alpharetta, GA (US)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/458,580

(22) Filed: Jul. 19, 2006

Related U.S. Application Data
(60) Provisional application No. 60/700,595, filed on Jul. 19, 2005.

(51) Int. Cl. A62B 9/02

(52) U.S. Cl. 128/205.24

(57) ABSTRACT

A gas regulating assembly controlling the pressure of gas from a gas reservoir to a pneumatically-operated device includes a primary housing surrounding a pair of gas regulators. The gas regulators are aligned in series within the primary housing between an inlet to receive high pressure gas and an outlet for releasing a controlled pressure gas. Each gas regulator includes a sealable valve that defines an input and an output, with each valve including a piston having a cylinder and a rod. A spring is adjacent said piston to force said piston cylinder away from said corresponding inlet, and a shim proximate said spring to adjust the force applied by said spring on said piston cylinder. Each valve allows gas to traverse the corresponding gas regulator until a predetermined pressure is achieved in the respective outlet of the respective gas regulator, at which point the predetermined pressure will close the corresponding valve.

### CROSS REFERENCE TO RELATED PATENT APPLICATIONS

This patent application claims priority from U.S. Provisional Patent Application No. 60/700,595, filed on Jul. 19, 2005, which is hereby incorporated by reference.

### BACKGROUND OF THE INVENTION

Because small pneumatically operated devices require a supply of pressurized gas at constant pressure, many use a small tank, connected to a regulator that is attached to the device. For portability reasons, size of the respective parts becomes an important consideration. Current regulators require housings that are relatively large and difficult to machine, with air passages at an angle to the direction of flow.

### SUMMARY OF THE INVENTION

The invention described herein provides for a gas regulating assembly for controlling the pressure of gas from a gas reservoir to a pneumatically-operated device includes a primary housing for a pair of gas regulators. The gas regulators are aligned in series in the primary housing between a gas inlet to receive high pressure gas and a gas outlet for releasing a regulated gas at a predetermined pressure. Each gas regulator includes a sealable valve that defines an input and an output, with each valve including a piston having a cylinder and a rod. A spring is adjacent said piston to force said piston cylinder away from said corresponding inlet, and a shim proximate said spring to adjust the force applied by said spring on said piston cylinder. Each valve allows gas to traverse the corresponding gas regulator until a predetermined pressure is achieved in the respective outlet of the respective gas regulator, at which point the predetermined pressure will close the corresponding valve.

The gas regulating assembly provides a miniature and stable assembly, with a simple housing that requires no complex machining and no undesired passages for gas flow in the housing. An embodiment of the gas regulating assembly provides a two stage design, so that as the supply pressure changes, for instance as the gas in the reservoir is consumed, the output pressure remains substantially constant for use in a pneumatically-operated device.

### DESCRIPTION OF THE DRAWINGS

A two-stage gas regulator embodying the features of the present invention is depicted in the accompanying drawings, which form a portion of this disclosure, wherein:

FIG. 1 is a sectional view of the two-stage gas regulator assembly fit in a housing;

FIG. 2 is a sectional view of the gas regulator of FIG. 1, the present view illustrating the flow of gas through the two-stage gas regulator assembly;

FIG. 3 is a sectional view of the two-stage gas regulator assembly;

FIG. 4 is a sectional view of a first one of the two-stage gas regulator assembly;

FIG. 5 is a sectional view of a second stage of the two-stage gas regulator assembly; and

FIG. 6 is a block diagram of the gas regulating assembly in operation between a pneumatically-operated device and a gas reservoir.

### DESCRIPTION OF THE PREFERRED EMBODIMENT

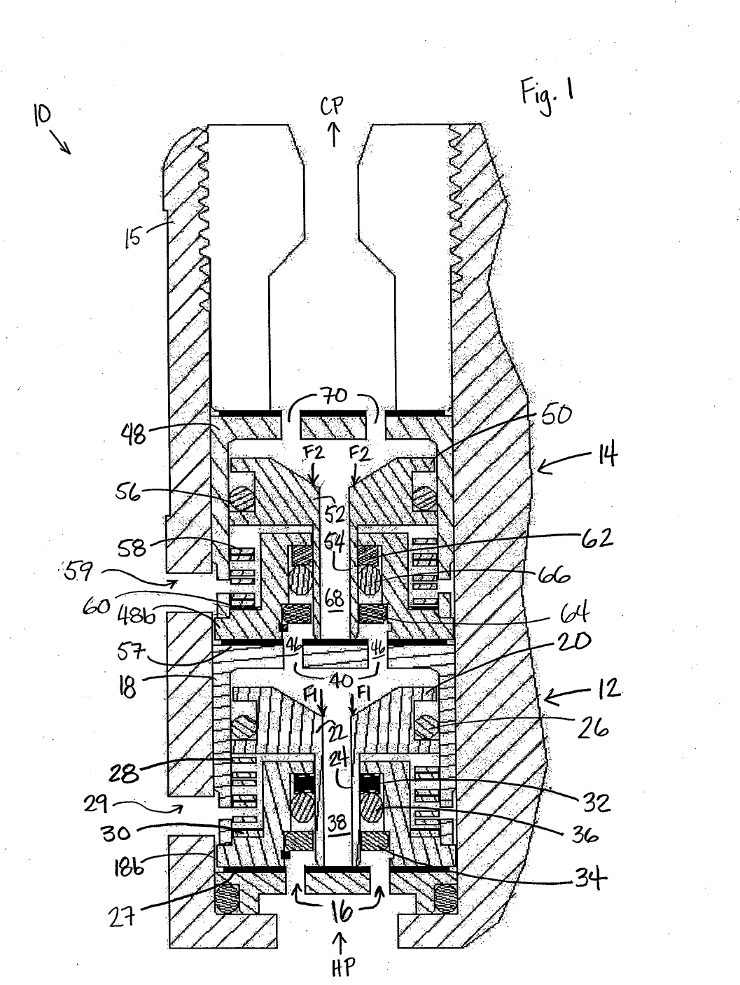

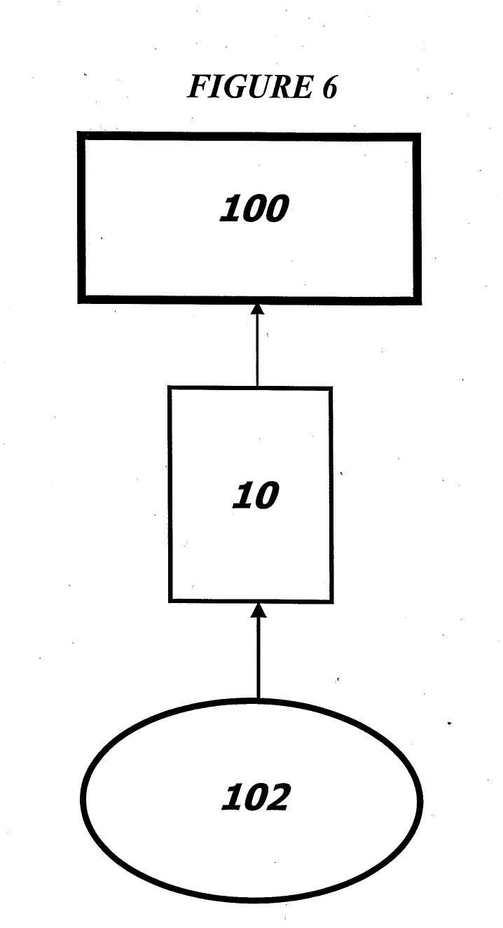

Looking to FIGS. 1, 2 and 6, one embodiment of a two-stage gas or fluid regulator assembly 10 used between a gas reservoir 102 and pneumatically-operated device 100 is illustrated. The gas regulator assembly 10 includes two unbalanced regulators 12, 14 (stage one and stage two, respectively) that are arranged in series in a primary housing 15, such as a cartridge or other housing, that includes a base 19 or other supporting member. The two regulators 12, 14 control the gas pressure from a high pressure gas HP provided from a gas reservoir 102. The gas regulator assembly 10 has an inlet 16 where the high pressure gas HP enters the stage one, or proximal, regulator 12, and the stage one regulator 12 will regulate the gas to provide such that a moderate or intermediate gas pressure is present at the input into the stage two, or distal, regulator 14. The stage two regulator 14 will further regulate the gas pressure to the desired output 70 at a controlled pressure CP.

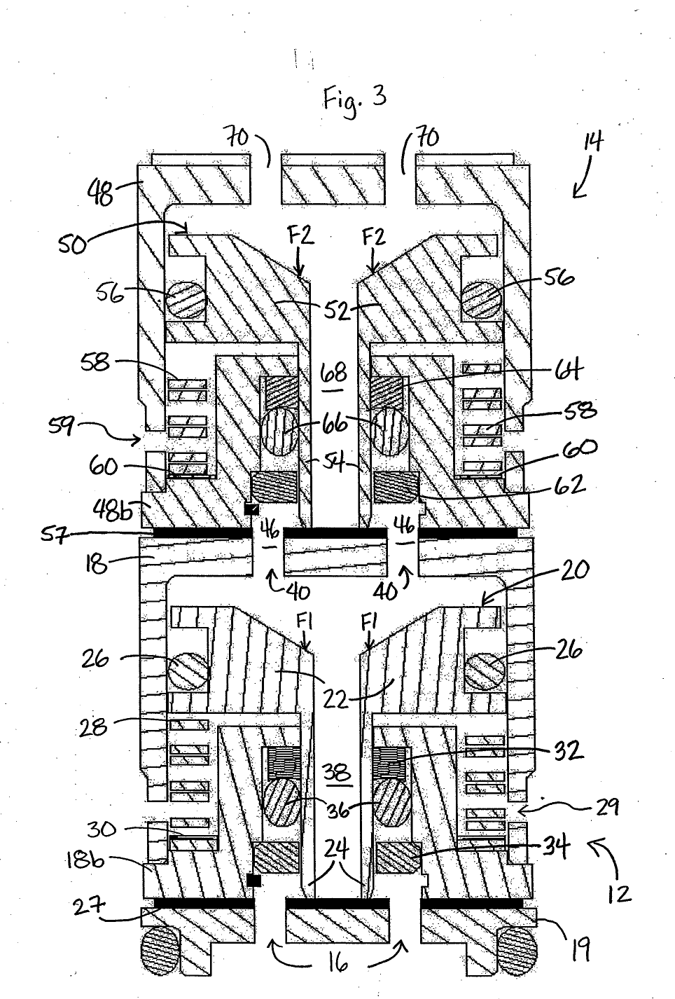

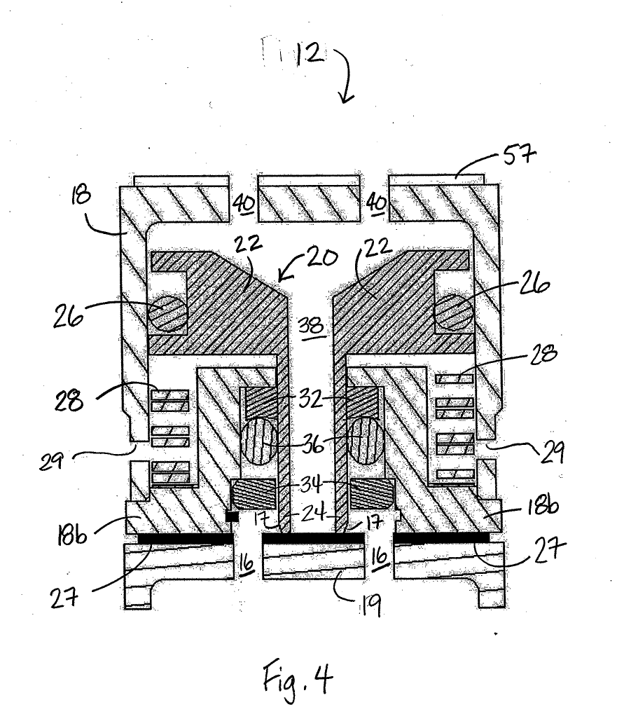

Referring now to FIGS. 3 and 4, the stage one regulator 12 is illustrated. The stage one regulator 12 includes a regulator housing 18 that surrounds a first piston 20. The piston 20 is slidably positioned in the regulator housing 18, and includes a piston cylinder or block 22 with a recessed central surface connected above a piston rod or shaft 24. A cylinder O-ring 26 is positioned between the piston cylinder 22 and the regulator housing 18. Furthermore, the regulator housing 18 includes a base member 18b that is connected to first seat 27. The first seat 27 is separated to provide one or more first stage inlets 16 that are in communication with the high pressure gas HP. A first spring 28 is positioned between the piston cylinder 22 and the base member 18b, and a shim 30 or series of shims is further positioned between the first spring 28 and the base member 18b, as discussed herein. The cavity containing the first spring 28 is vented to the atmosphere via a first atmospheric vent 29, which may extend through the primary housing 15 and the regulator housing 18. Thus, a constant relationship between regulated pressure and atmospheric pressure is maintained around the first spring 28. Positioned between the base member 18b and the piston cylinder 22 are a back-up ring 32, a retainer 34, and an annulus O-ring 36. Finally, a hollow channel 38 traverses the piston 20 connecting the stage one inlet 16 with a stage one outlet 40.

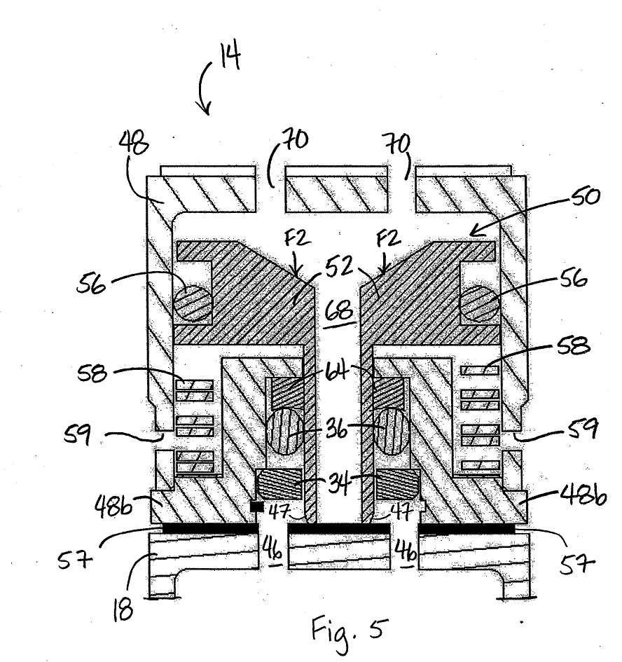

Referring now to FIGS. 3 and 5, the stage two regulator 12 is illustrated, which includes a regulator housing 48 that surrounds a first piston 50. The second piston 50 is slidably positioned in the regulator housing 48, and includes a piston cylinder 52 with a recessed central surface connected above a piston shaft 54. A cylinder O-ring 56 is positioned between the piston cylinder 52 and the regulator housing 48. Furthermore, the regulator housing 48 includes a base member 48b that is connected to second seat 57. The second seat 57 is separated to provide one or more second stage inlets 46 that correspond with the stage one outlets 40 and are in communication with the medium gas pressure. A second spring 58 is positioned between the piston cylinder 52 and the base member 48b, and a shim 60 or series of shims 60 is further positioned between the second spring 58 and the base member 58b, as discussed herein. The cavity containing the second spring 58 is vented to the atmosphere via a first atmospheric vent 59, which may extend through the primary housing 15 and the regulator housing 48. Thus, a constant relationship between regulated pressure and atmospheric pressure is maintained around the second spring 58. Positioned between the base member 48b and the piston cylinder 52 are a back-up ring 62, a retainer 64, and an annulus O-ring 66. Finally, a hollow channel 68 traverses the piston 50 connecting the stage two inlets 56 with a stage two outlet 70.

Looking to FIGS. 1 through 5, the cavities containing the springs 28, 58 are vented to the atmosphere via atmospheric vents 29, 59. The atmospheric vents 29, 59 may extend through the primary housing 15 and the respective regulator housings 18, 48. Thus, a constant relationship between regulated pressure and atmospheric pressure is maintained in each regulator 12, 14.

As noted above, there are multiple seals between the pistons 20, 50 and their respective regulator housings 18, 48. The seal on the regulated side of each piston 20, 30 proximate the piston cylinder 52 is the standard piston-type o-ring 26, 56, which actually becomes part of the piston 20, 30. In addition, the piston rod 24, 54 of the respective piston 20, 30 provides the high pressure seal, and an annulus O-ring 36, 66 extends around the piston rod 24, 54 so that the o-ring 26, 56 does not contribute area to the imbalance forces.

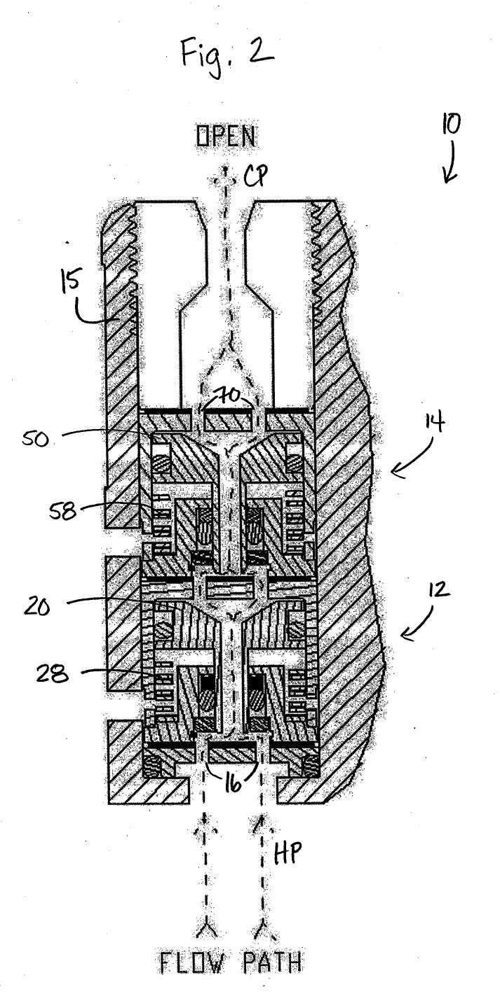

Referring now to FIG. 2, when the gas regulating assembly 10 is initially connected to the gas reservoir 102, or when the gas reservoir 102 is filled with the high pressure gas HP, the pistons 20, 50 of both stage regulators 12, 14 will be displaced from their corresponding seats 27, 57 by the force of the respective spring 28, 58. The high pressure gas HP will enter the gas regulating assembly 10 through the first stage regulator 12. That is, the spring 28 will tend to lift the piston 20 off of the first seat 24, thereby allowing gas to flow through the first passage 38 into the second stage regulator 14. As the gas exits the first stage 12 at the outlet 40, it will flow into to the entrance 46 of second stage 14. The second spring 58 will tend to lift the second piston 50 off of a second seat 57, thereby allowing gas to flow through a second passage 68 traversing the second piston 30 into the second stage regulator 14 and exiting at outlet 70 for use by a pneumatically-operated device 100.

As pressure in the outlet 70 of the second stage 14 increases to be used by the pneumatically-operated device 100, a force F2 proportional to the pressure in said outlet 70 will develop on the second piston 50. This force F2 will counteract the force of the second spring 58, and when the force F2 is great enough, the second piston 30 will be forced against the second seat 57, thus preventing gas flow through the second passage 68 traversing the second piston 50. As a result, the gas supplied from the second stage 14 is maintained at a controlled pressure CP as desired the user.

Similar to the operate of the stage two regulator 14, as pressure in the outlet 40 of stage one regulator 12 increases, a force F1 proportional to the intermediate pressure in said outlet 40 will develop on the piston 20. This force F1 counteracts the force of the spring 28, and when the force F1 is great enough, the piston 20, and in particular, the piston rod 24 will be forced against the first seat 27. Once the piston rod 24 abuts the first seat 27, the first passage 38 traversing the piston 20 will be blocked preventing further gas flow through the first passage 38. Thus, the variable high pressure gas HP from the gas reservoir 102 will be managed at a consistent pressure CP that is usable by the corresponding pneumatically-operated device 100.

As provided above, the high pressure gas HP from the gas reservoir 102 will initially engage the inlet 16 at a high pressure. However, once the high pressure gas HP has been released to the gas regulating assembly 10, the pressure of the high pressure gas HP will decrease. Furthermore, the pressure will continue to decrease as the pneumatically-operated device 100 is operated, such that the pressure of the high pressure gas HP will eventually be equivalent to the atmospheric pressure and consequently not provide the necessary requirements for operation of the pneumatically-operated device 100 until the reservoir 102 is replenished or a new reservoir 102 is connected to the gas regulating assembly 10. Nevertheless, as the pressure of the high pressure gas HP varies, the gas regulating assembly 10 will continue to provide the controlled gas CP having a pressure needed for proper operation of the pneumatically-operated device 100.

Axial flow of gas occurs through the channels 38, 68 traversing the piston 20, 50. The high pressure HP initially engages the gas regulator assembly 10 at the outside surface of the piston rod 24. The seat 27, 57 of each regulator 12, 14 may include a rubber surface. With respect to the stage one regulator 12, the distal edge of the piston rod 24 will substantially seal the channel 38 when the piston rod 24 abuts against the seat 27.

Most of the imbalance in a gas regulator assembly 10 is a function of the ratio of the area of the piston 20, 30 exposed to the regulated pressure that tends to close the respective gas regulator 12, 14, and the area exposed to the high pressure that tends to open the respective gas regulator 12, 14. The greater this ratio, the less imbalance the regulator displays. Conventional gas regulators use large pistons or diaphragms to solve this problem, but that is prohibitive when the design is to fit into a small space or a small housing, such as a cartridge. Since one objective of this gas regulator assembly 10 is to minimize the size occupied by the assembly 10, a large piston was not feasible. Consequently, each stage regulator 12, 14 minimizes the area exposed to high pressure. When the piston rod 24, 54 engages the seat 27, 57, high pressure is substantially maintained on the side of the piston rod 24, 54 and regulated pressure on the inside. The seal takes place across the cross section of the wall of the piston rod 24, 54 at the end of the piston 20, 50. The area of the piston 20, 30 exposed to the high pressure gas HP, which tends to displace the piston 20, 30 from the respective seat 27, 57, is the area from the retainer 34, 64 and annulus O-ring 36, 66 from the outside of the piston rod 20, 30 to a lead-in 17, 47 where the final seal of the piston rod 20, 30 occurs on the seat 27, 57. By making the wall of the piston rod 20, 30 thin, this area exposed to the high pressure gas HP is minimized.

Stage one 12 and stage two 14 are functionally identical and are interchangeable. The springs 28, 58 of each stage 12, 14 are designed with a high spring constant (k) so that very small changes in preload can cause significant changes in spring force. That is, the addition of thin shims 30, 60 between the springs 28, 58 and base member 28b, 48b can substantially adjust the spring force applied to the respective piston 20, 50. The output pressure is set by the addition of a shim 33, 43 or shims under the respective spring 22, 32 to increase the preload, and thereby the output pressure 28, 38. The spring constants k of the first and second regulating stages 12, 14 are set individually to the desired output pressure, although the spring constants k of each spring 28, 58 may be equivalent. Therefore, the springs 28, 58 and shims 30, 60 will determine the output pressure, with the input pressure slightly above the desired output pressure.

As an example, if 150 PSI is the desired output pressure, the regulator stages 12, 14 would be set to 150 PSI at 200 PSI input pressure. With this arrangement, as the reservoir 102 pressure drops from 3,000 PSI to 200 PSI, the output from the first stage 12 would vary from about 240 PSI to 150 PSI, and the output from the second stage 14 would vary from around 155 PSI to 150 PSI. Thus, by arranging the first stage regulator 12 and the second stage regulator 14 in series, the user is able to regulate the high pressure HP flowing into the assembly 10 into which a controlled pressure CP flows from the assembly 10.

More specifically, the high pressure gas is regulated by the stage one regulator 12 to a pressure that is at all times greater than the desired final outlet controlled pressure CP. Due to the imbalance, the outlet 40 of the stage one regulator 12 will vary depending on the pressure at the inlet 16 of the stage one regulator 12. For instance, as the inlet pressure HP varies from 3,000 to 300 PSI, the outlet pressure from stage one 12 may vary from 300 to 200 PSI. This intermediate regulated pressure at the outlet 40 is then directed into a substantially identical, stage two regulator 14, which further adjusts the gas pressure to the desired controlled pressure CP at the second outlet 70. As the outlet pressure from stage one 12 varies from 300 to 200 PSI, the outlet pressure from stage two 14 may vary from 155 to 153 PSI. Thus, by using two unbalanced regulators 12, 14 in series, the output control pressure CP from the gas regulating assembly 10 remains effectively constant as the input pressure HP varies.

An important aspect of this design includes its small size. The entire gas regulating assembly 10 can be positioned in a small cavity, such as a circular cavity that is only 0.545 inches in diameter and just over one inch long. Another important aspect is the fact that all flow and sealing is axial, thus no external sealing is required. Since no external sealing is required, manufacturing the cavity becomes much simpler and therefore cheaper. In particular, no O-ring grooves need to be machined into the cavity, and the overall tolerances and finish requirements can be much looser. The only requirement is that there be a seal at the ends of the cavity

While this invention has been described with reference to preferred embodiments thereof, it is to be understood that variations and modifications can be affected within the spirit and scope of the invention as described herein and as described in the appended claims.

What is claimed is:

1. A gas regulating assembly for controlling the pressure of gas from a gas reservoir to a pneumatically-operated device comprising:
a primary housing having a support;
a first stage gas regulator positioned in said primary housing on said support, said first stage gas regulator having an inlet receiving a high pressure gas from the gas reservoir and an outlet providing a regulated gas at an intermediate pressure; and
a second stage gas regulator positioned in said primary housing proximate said outlet of said first stage gas regulator, said second stage gas regulator having an inlet receiving the intermediate regulated gas and an outlet distributing a regulated gas at a controlled pressure to the pneumatically-operated device.

2. The gas regulating assembly as described in claim 1, wherein said first stage regulator comprises:
a first regulator housing having a first base member, said first regulator housing defining a gas inlet and a gas outlet;
a first piston movably positioned in said first regulator housing;
a first spring positioned between said first piston and said first base member, said first spring applying a first spring force on said piston away from said first base member; and
a first passage traversing said first piston to periodically connect said gas inlet of said first regulator housing with said gas outlet of said first regulator housing.

3. The gas regulating assembly as described in claim 2, wherein said first piston comprises:
a piston cylinder and a piston rod, said first passage traversing said piston cylinder and said piston rod; said first spring positioned between said piston cylinder and said first base member.

4. The gas regulating assembly as described in claim 3 further comprising a cylinder O-ring intermediate said piston cylinder and said first regulator housing.

5. The gas regulating assembly as described in claim 3 further comprising an annulus O-ring around said piston rod, said annulus O-ring positioned between said piston rod and said first base member.

6. The gas regulating assembly as described in claim 2 further comprising at least one shim intermediate said first spring and said first base member.

7. The gas regulating assembly as described in claim 2 further comprising a first air vent traversing said primary housing and said first regulator housing to connect said first spring with atmospheric pressure.

8. The gas regulating assembly as described in claim 2, wherein said second stage regulator comprises:
a second regulator housing having a second base member, said second regulator housing defining a gas inlet and a gas outlet;
a second piston movably positioned in said second regulator housing;
a second spring positioned between said second piston and said second base member, said second spring applying a second spring force on said second piston away from said first base member; and
a second passage traversing said second piston to periodically connect said gas inlet of said second regulator housing with said gas outlet of said second regulator housing.

9. The gas regulating assembly as described in claim 8, wherein said second piston comprises:
a piston cylinder and a piston rod, said second passage traversing said piston cylinder and said piston rod; said second spring positioned between said piston cylinder and said second base member.

10. The gas regulating assembly as described in claim 9 further comprising a cylinder O-ring intermediate said piston cylinder and said second regulator housing.

11. The gas regulating assembly as described in claim 9 further comprising an annulus O-ring around said piston rod, said annulus O-ring positioned between said piston rod and said second base member.

12. The gas regulating assembly as described in claim 9 further comprising at least one shim intermediate said second spring and said second base member.

13. The gas regulating assembly as described in claim 9 further comprising a second air vent traversing said primary housing and said second regulator housing to connect said second spring with atmospheric pressure.

14. A gas regulating assembly for controlling the pressure of gas from a gas reservoir to a pneumatically-operated device comprising:
a primary housing having a support;
a proximal gas regulator positioned in said primary housing on said support, said proximal gas regulator having a proximal inlet receiving a high pressure gas from the gas reservoir, a proximal outlet providing a regulated gas at an intermediate pressure, and a proximal valve positioned between said proximal inlet and said proximal outlet allowing gas to traverse the proximal gas regulator until a predetermined pressure is achieved at said proximal outlet to close said proximal valve; and
a distal gas regulator positioned in said primary housing adjacent said proximal outlet of said proximal gas regulator, said distal gas regulator having a distal inlet receiving the intermediate regulated gas, a distal outlet distributing a regulated gas at a controlled pressure to the pneumatically-operated device, and a distal valve positioned between said distal inlet and said distal outlet allowing gas to traverse the distal gas regulator until a predetermined pressure is achieved at said distal outlet to close said proximal valve.

15. The gas regulating assembly as described in claim 14, wherein said proximal gas regulator comprises:
a proximal regulator housing having a proximal base member, said proximal regulator housing defining said proximal gas inlet and said proximal gas outlet;
wherein said proximal valve comprises a proximal piston movably positioned in said proximal regulator housing and having a proximal piston cylinder and a proximal piston shaft;
at least one proximal spring positioned between said proximal piston cylinder and said proximal base member, said proximal spring applying a proximal spring force on said proximal piston cylinder away from said proximal base member;
a first channel traversing said proximal piston to periodically connect said proximal gas inlet with said proximal gas outlet when said proximal piston is displaced from said proximal base member;
a distal regulator housing having a distal base member, said distal regulator housing defining said distal gas inlet and said distal gas outlet;
wherein said distal valve comprises a distal piston movably positioned in said distal regulator housing and having a distal piston cylinder and a distal piston shaft;
at least one distal spring positioned between said distal piston cylinder and said distal base member, said distal spring applying a distal spring force on said distal piston cylinder away from said distal base member; and
a second channel traversing said distal piston to periodically connect said distal gas inlet with said distal gas outlet when said distal piston is displaced from said distal base member.

16. The gas regulating assembly as described in claim 15 further comprising:
means for sealing said proximal piston cylinder in said proximal regulator housing; and
means for sealing said distal piston cylinder in said distal regulator housing.

17. The gas regulating assembly as described in claim 15 further comprising:
means for sealing said proximal piston rod with said proximal base member; and
means for sealing said distal piston rod with said distal base member.

18. The gas regulating assembly as described in claim 15 further comprising:
at least one proximal shim intermediate said proximal spring and said proximal base member; and
at least one distal shim intermediate said distal spring and said distal base member.

19. A gas regulating assembly for controlling the pressure of gas from a gas reservoir to a pneumatically-operated device comprising:
a primary housing; and
a pair of gas regulators positioned in series in said primary housing between an inlet to receive high pressure gas and an outlet for releasing controlled pressure gas, each gas regulator having a sealable valve defining an input and an output, each said valve allowing gas to traverse said corresponding gas regulator until a predetermined pressure is achieved in said respective outlet of said corresponding gas regulator.

20. The gas regulating assembly as defined in claim 19 wherein each said valve comprises a piston having a cylinder, a rod and a channel traversing said cylinder and rod; and further comprising a spring adjacent said piston to force said piston cylinder away from said corresponding inlet and a shim proximate said spring to adjust the force applied by said spring on said piston cylinder.
